(19) United States
(12) Patent Application Publication
(10) Pub. No.: US 2009/0146786 A1
(43) Pub. Date: Jun. 11, 2009

(54) MEASURING DEVICE

(75) Inventors: Akinori Toma, Tokyo (JP); Shuji Kurokawa, Tokyo (JP); Yoshiaki Sugishita, Tokyo (JP)

Correspondence Address: NORRIS, MCLAUGHLIN & MARCUS, P.A., 875 THIRD AVE, 18TH FLOOR, NEW YORK, NY, 10022, US

(73) Assignee: LINTEC CORPORATION, TOKYO (JP)

(21) Appl. No.: 12/089,540

(22) PCT Filed: Oct. 4, 2006
(86) PCT No.: PCT/JP2006/319837

§ 371 Date: Apr. 8, 2008

(30) Foreign Application Priority Data
Oct. 17, 2005 (JP) 2005-301772

(51) Int. Cl. H04Q 5/22; G01B 11/26

(52) U.S. Cl. 340/10.1; 702/150

(57) ABSTRACT

[Problem to be Solved] To provide a measuring device preferable to enhance capability of pickup processing when picking up each chip of a plate-shaped member individually separated into a form of chips.

[Solution] A semiconductor wafer 4 as a plate-shaped member supported by a support member H which is consisted of an adhesive sheet 3 and a ring frame 2, the adhesive sheet is stuck to an opening of the ring frame 2, and individually separated into a form of chips by cutting is set as a measurement target; an image processing unit 5 measures a chip interval G and a misalignment angle θ, and measurement data D of them is sent from the image processing unit 5 to a host computer 6, and stored in storage means 12 of the host computer 6; and based on the chip interval G and the misalignment angle θ stored in the storage means 12, position recognition processing at the time of confirming the position of a chip with a recognition unit of a pickup device, for example, a camera, and correction processing of aligning the position of a collet for pickup with the recognized position can be carried out in the next step.

### TECHNICAL FIELD

The present invention relates to a measuring device for measuring each chip interval and misalignment angle of a plate-shaped member stuck to an adhesive sheet.

### BACKGROUND ART

Conventionally, in the manufacturing process of a semiconductor element or a light emitting diode element, a semiconductor wafer or a compound wafer supported by ring frames via sheets is individually separated into a form of chips by dicing, and thereafter, in order to pick up the chips, the above described adhesive sheet is expanded into a predetermined amounts by an expander to expand chip intervals of the semiconductor wafer or the compound wafer individually separated into the form of chips (see, for example, Patent Document 1).

However, according to the above described expander, when expanding the chip intervals of the semiconductor wafer or the compound wafer which is individually separated into the form of chips, the chip intervals and the misalignment angle between the cut line by the above described dicing and the ring frame are not measured. Therefore, when positions of the chips are confirmed with a recognition unit, for example, a camera, of the pickup device at the time of picking up the chips, much time is taken for processing of recognizing the positions of the chips, and correction processing of aligning the position of a collet for pickup with the recognized positions, and there arises the problem of reduction in throughput.

Patent Document 1: Japanese Patent No. 3064979

### DISCLOSURE OF THE INVENTION

### Problems to be Solved by the Invention

The present invention is made to solve the above described problem, and its object is to provide a measuring device preferable for enhancing the capability of pickup processing when picking up each chip of a plate-shaped member individually separated into a form of chips.

### Means for Solving the Problems

In order to attain the above described object, a measuring device according to the present invention is a measuring device setting a plate-shaped member supported by a support member which is consisted of an adhesive sheet and a ring frame, the adhesive sheet being stuck to an opening of the ring frame, and individually separated into a form of chips by cutting as a measurement target, and measuring each chip interval, and the measuring device includes image processing means measuring the chip interval, and storage means storing the chip interval measured by the image processing means as measurement data.

Further, in order to attain the above described object, a measuring device according to the present invention is a measuring device setting a plate-shaped member supported by a support member which is consisted of an adhesive sheet and a ring frame, the adhesive sheet being stuck to an opening of the ring frame, and individually separated into a form of chips by cutting as a measurement target, and measuring a misalignment angle between a cut line by the cutting and a reference direction of the ring frame, and the measuring device includes image processing means measuring the misalignment angle, and storage means storing the misalignment angle measured by the image processing means as measurement data.

Further, in order to attain the above described object, a measuring device according to the present invention is a measuring device setting a plate-shaped member supported by a support member which is consisted of an adhesive sheet and a ring frame, the adhesive sheet being stuck to an opening of the ring frame, and individually separated into a form of chips by cutting as a measurement target, and measuring each chip interval and a misalignment angle between a cut line by the cutting and a reference direction of the ring frame, and the measuring device includes image processing means measuring the chip interval and the misalignment angle, and storage means storing the chip interval and the misalignment angle measured by the image processing means as measurement data.

The above described measuring device according to the present invention may be constituted to further include output means outputting the measurement data stored in the storage means.

The above described measuring device according to the present invention may be constituted to further include printing means converting the measurement data into an optical readable code and printing the optical readable code onto a label, and sticking means sticking the label attached with the optical readable code to the support member.

The above described measuring device according to the present invention may be constituted to further store the measurement data stored in the storage means into an electronic recording medium and output the measurement data to another device.

The above descried measuring device according to the present invention may be constituted to further include write means writing the measurement data stored in the storage means into an RFID tag, and sticking means sticking the RFID tag in which the measurement data is written to a predetermined position.

### EFFECT OF THE INVENTION

As described above, the measuring device according to the present invention adopts the constitution in which a plate-shaped member supported by a support member which is consisted of an adhesive sheet stuck to an opening of a ring frame and individually separated into a form of chips by cutting is set as a measurement target, measures the chip interval or/and the misalignment angle of a chip is or are measured by the image processing means, and the measurement data is stored in the storage means. Therefore, the chips can be picked up based on the chip intervals or/and chip misalignment angles stored in the above described storage means. Therefore, time for position recognition processing at the time of confirming the position of a chip with the recognition unit, for example, a camera of the pickup device and correction processing of aligning the position of a collet for pickup with the recognized position can be shortened, and the operational effect of being able to enhance the capability of pickup processing can be obtained.

### BEST MODE FOR CARRYING OUT THE INVENTION

Hereinafter, the best mode for carrying out the present invention will be described in detail with reference to the attached drawings.

FIG. 1 is an explanatory view of a measuring device according to the present invention, FIG. 2 is an explanatory view of a measurement target, a misalignment angle and a sticking configuration of a bar code, and FIG. 3 is an explanatory view of a measurement position of a chip interval.

A measuring device 1 of FIG. 1 sets a plate-shaped member (a semiconductor wafer which has been subjected to dicing in the present embodiment (hereinafter, abbreviated as “wafer 4”)) which is supported by a support member H with an adhesive sheet 3 stuck to an opening of a ring frame 2 as shown in FIG. 2 and individually separated into a form of chips by cutting, as a measurement target, and measures each chip interval G (see FIG. 3) and a misalignment angle θ which will be described later.

Each chip interval G of the wafer 4 is expanded into a predetermined amount with an expander, which is not illustrated, in advance before start of measurement by the measuring device 1. The reason why the chip interval G is expanded into a predetermined amount as described above is to pick up the chips C one by one with a collet of a pickup device, which is not illustrated, after the measurement with the measuring device 1 is finished.

In order to carry out the measurement as described above, the measuring device 1 includes an image processing unit (image processing means) 5, a host computer 6, a printer 7 and a monitor 8, and adopts the constitution in which the image processing unit 5, the printer 7 and the monitor 8 are connected to the host computer 6.

The image processing unit 5 is constituted to photograph the wafer 4 on the adhesive sheet 3 with its camera 9, capture the image and measure the chip interval G and the misalignment angle θ from the captured image. The above described “chip interval G” is a distance between the two adjacent chips C as shown in FIG. 3, and the above described “misalignment angle θ” is an angle formed by a predetermined axis Y (reference direction of the ring frame) set with two notches 10, 10 provided in the ring frame 2 as the reference, and a dicing line (cut line) 11 cut by dicing as shown in FIG. 2. As the reference of the predetermined axis Y, a flat part 29 of the ring frame 2 may be set as the reference instead of the notches 10 and 10.

In the present embodiment, the measurement of the chip interval G is constituted so that performed at a plurality of spots as shown by the arrows in FIG. 3. As measurement data D, measurement data Da of the individual chip intervals, average data Db of the chip intervals and measurement data Dc of the misalignment angle θ are obtained. In order to enhance reliability of the average when obtaining the average data Db, processing of rejecting the measurement data (D1 to D9 in FIG. 3) relating to a defective portion C1 of the chip C and an omitted portion C2 of the chip C is performed in the image processing unit 5.

Each measurement data D is outputted from the image processing unit 5 to the host computer 6, and is stored in storage means 12, for example, a hard disk, of the host computer 6. The stored measurement data D can be outputted from the host computer 6 to another device. As the storage means 12, a floppy (registered trademark) disk, a USB memory, a CD-R, a CD-RW, a DVD-R, a DVD-RW, a DVD-RAM, an MO, a magnetic tape and the like are conceivable in addition to the hard disk.

The printer 7 functions as the means for printing out the measurement data D of the chip C sent to the host computer 6 as described above, and the monitor 8 functions as the means for displaying the measurement data D.

The measurement data D can be stuck to the support member H as the bar code 13 as shown in FIG. 2 by adopting the constitution shown in FIG. 4.

More specifically, as shown in FIG. 4, a CPU 14 takes in the measurement data D from the image processing unit 5, and converts the measurement data D into bar code data BD known as an optical readable code and outputs it to a bar code printer 15 (printing means). In the bar code printer 15, a label material 18 formed by temporarily sticking a plurality of labels 17 at predetermined pitches on a web-shaped release liner 16 is conveyed to a peel plate 19, and a print head 22 prints the bar code 13 on the label 17 during the conveyance. The label 17 on which the bar code 13 is printed is folded back in a direction opposite from the conveying direction with the peel plate 19, and thereby, is peeled from the release liner 16 to be held by a suction grid 21 of a sticking device 20. Thereafter, the label 17 is stuck to the adhesive sheet 3 of the support member H by descent of the suction grid 21. The CPU 14 may be a CPU (not illustrated) of the host computer 6. As the printing means, a dot impact printer, a thermal printer, a laser printer and the like are conceivable.

Instead of the bar code 13 (one-dimensional code), a known QR code (two-dimensional code) (not illustrated) can be adopted as an optical readable code. In this case, the CPU 14 is constituted to convert the measurement data D of the chip C into QR code data and outputs it to the bar code printer 15, so that the bar code printer 15 prints the QR code onto the label 17 with a print head 22 based on the QR code data.

The wafer 4 as the measurement target in which the label 17 printed a bar code or a QR code is stuck to the support member H as described above is conveyed to a pickup device, which is not illustrated, and the chips C are picked up with a collet for pickup. At this time, the pickup device reads the bar code 13 or the QR code from the label 17 by a bar code reader or a QR code reader first, acquires the measurement data D of the chip C from the bar code 13 or the QR code, and can use the measurement data D for preparation of pickup, correction of the position of the collet for pickup and the like by performing alignment based on the measurement data D.

As the method in which the other device (pickup device in this embodiment) acquires the measurement data D as described above, for example, the host computer 6 may output the measurement data D stored in its storage means 12 to the other device by radio or wire communication. In this case, the host computer 6 functions as the output means which outputs the measurement data D to the other device. Further, the measurement data D which is stored in the storage means of the host computer 6 can be provided to the other device by being stored in an electronic recording medium such as a floppy (registered trademark) disk, and a USB memory.

Further, by adopting the constitution shown in FIG. 5, more measurement data D can be stored in an RFID tag 24 and the RFID tag 24 is stuck to a predetermined position.

More specifically, as shown in FIG. 5, a CPU 25 takes in the measurement data D from the image processing unit 5, and outputs the measurement data D to an RFID tag issuing machine 26. In the RFID tag issuing machine 26, a tag material 30 formed by temporarily sticking a plurality of RFID tags 24 at predetermined pitches on the web-shaped release liner 16 is being conveyed to the peel plate 19, and during the conveyance, an RFID writer 27 writes the measurement data D to a storing part (not illustrated) of the RFID tag 24. The RFID tag 24 in which the measurement data D is written is folded back in a direction opposite from the conveying direction with the peel plate 19, and thereby, is peeled from the release liner 16 to be held by the suction grid 21 of the sticking device 20. Thereafter, the tag 24 is stuck to a predetermined position by descent of the suction grid 21. The CPU 25 may be a CPU (not illustrated) of the host computer 6.

As shown in FIG. 5, when a plurality of wafers 4 as the measurement targets are collectively handled by being loaded into a cassette 28, the RFID tag 24 may be stuck to the cassette 28. In this case, the measurement data D, of all the wafers 4 which present in the cassette 28, are stored in the storing part of the RFID tag 24. The place for sticking the RFID tag 24 is not limited to only a top board 28a of the cassette 28, but can be properly changed in accordance with necessity.

The measuring device 1 described above adopts the constitution in which the wafer 4 which is supported by the support member H with the adhesive sheet 3 stuck to the opening of the ring frame 2 and individually separated into a form of chips by cutting is used as the measurement target, the chip interval G and the misalignment angle θ are measured by the image processing unit 5, and the measurement data D is stored in the storage means 12. Therefore, preparation for picking up the chip C can be made based on the measurement data D of the chip intervals G and the misalignment angle θ stored in the storage means 12, time for position recognition processing at the time of confirming the position of the chip with a recognition unit of the pickup device, for example, a camera, and correction processing of aligning the collet for pickup with the recognized position can be shortened, and capability of pickup processing can be enhanced.

### BRIEF DESCRIPTION OF THE DRAWINGS

FIG. 1 is an explanatory view of a measuring device according to the present invention.

FIG. 2 is an explanatory view of a measurement target, a misalignment angle and a sticking constitution of a bar code.

FIG. 3 is an explanatory view of a measuring position of a chip interval.

FIG. 4 is an explanatory view of a constitution for sticking measurement data to a support member.

FIG. 5 is an explanatory view of another constitution for sticking measurement data to a predetermined adherend.

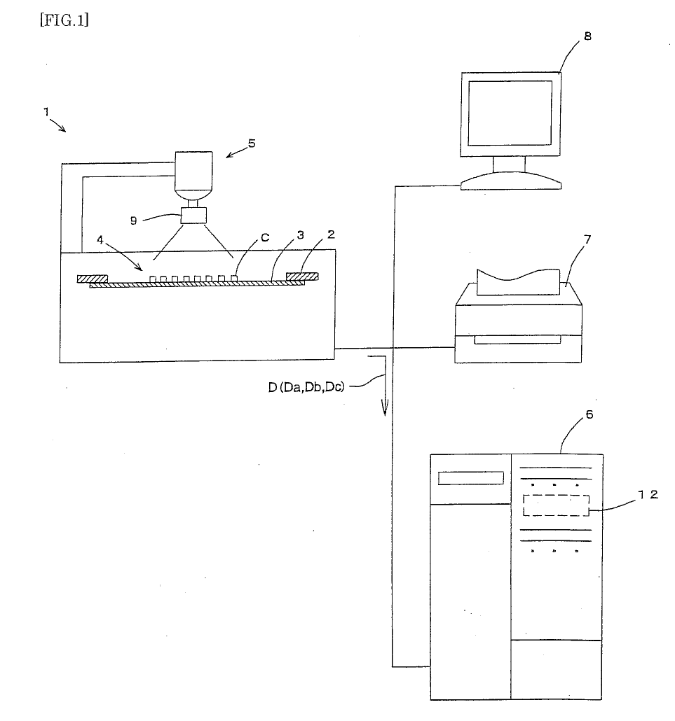

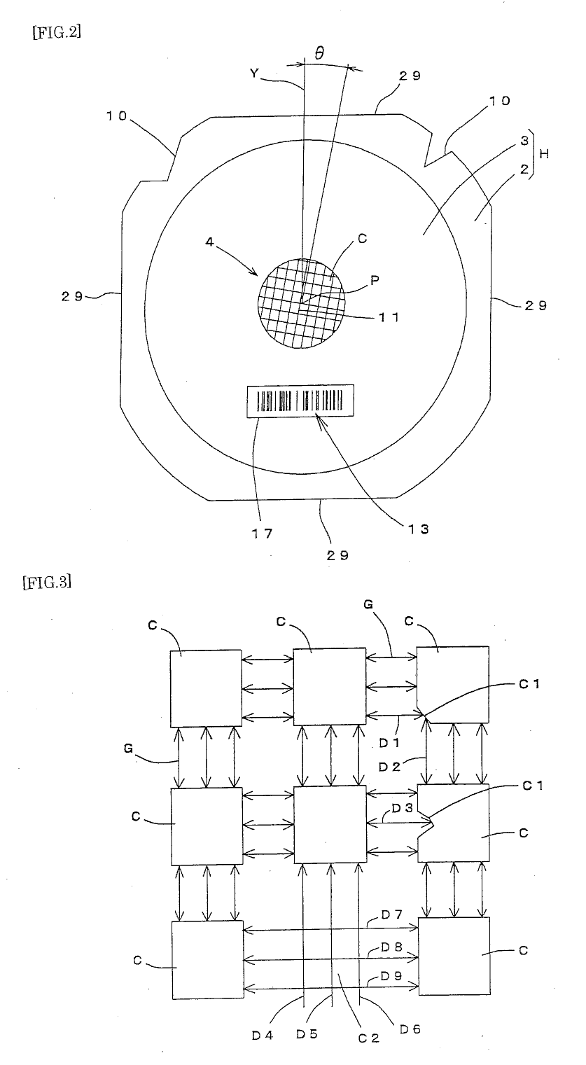

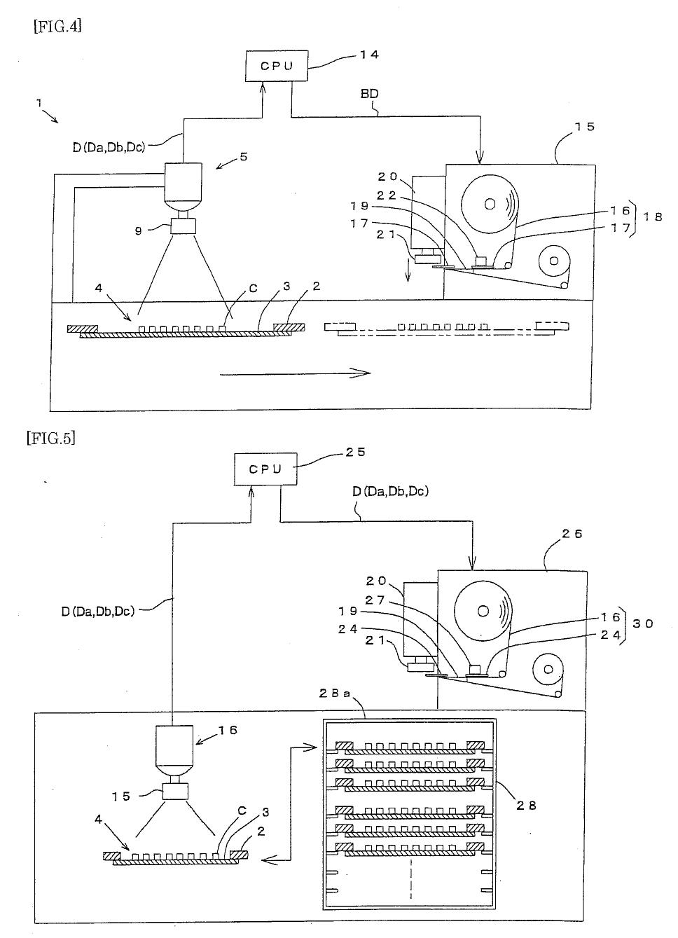

### DESCRIPTION OF SYMBOLS

1 Measuring device
2 Ring frame
3 Adhesive sheet
4 Wafer (plate-shaped member)
5 Image processing unit (image processing means)
11 Dicing line (cut line)
12 Storage means
13 Bar code (optical readable code)
15 Bar code printer (printing means)
17 Label
20 sticking device (sticking means)
24 RFID tag
26 RFID tag issuing machine (write means)
G Chip interval
θ Misalignment angle
D Measurement data
Da Measurement data of individual chip intervals
Y Axis (reference direction of ring frame)

1. A measuring device setting a plate-shaped member supported by a support member which is consisted of an adhesive sheet and a ring frame, said adhesive sheet being stuck to an opening of said ring frame, and individually separated into a form of chips by cutting as a measurement target, and measuring each chip interval,
said measuring device comprising:
image processing means measuring said chip interval; and
storage means storing said chip interval measured by said image processing means as measurement data.

2. A measuring device setting a plate-shaped member supported by a support member which is consisted of an adhesive sheet and a ring frame, said adhesive sheet being stuck to an opening of said ring frame, and individually separated into a form of chips by cutting as a measurement target, and measuring a misalignment angle between a cut line by said cutting and a reference direction of said ring frame,
said measuring device comprising:
image processing means measuring said misalignment angle; and
storage means storing said misalignment angle measured by said image processing means as measurement data.

3. A measuring device setting a plate-shaped member supported by a support member which is consisted of an adhesive sheet and a ring frame, said adhesive sheet being stuck to an opening of said ring frame, and individually separated into a form of chips by cutting as a measurement target, and measuring each chip interval and a misalignment angle between a cut line by said cutting and a reference direction of said ring frame,
said measuring device comprising:
image processing means measuring said chip interval and said misalignment angle; and
storage means storing said chip interval and said misalignment angle measured by said image processing means as measurement data.

4. The measuring device according to any one of claim 1, wherein said measuring device further comprises output means outputting said measurement data stored in said storage means.

5. The measuring device according to any one of claim 1, wherein said measuring device further comprises printing means converting said measurement data into an optical readable code and printing said optical readable code onto a label; and
sticking means sticking the label printed said optical readable code to said support member.

6. The measuring device according to any one of claim 1, wherein said measuring device further stores said measurement data stored in said storage means into an electronic recording medium and outputs said measurement data to another device.

7. The measuring device according to any one of claim 1, wherein said measuring device further comprises write means writing said measurement data stored in said storage means into an RFID tag; and
sticking means sticking the RFID tag in which said measurement data is written to a predetermined position.
